(19) United States
(12) Patent Application Publication
(10) Pub. No.: US 2022/0367894 A1
(43) Pub. Date: Nov. 17, 2022

(54) FUEL CELL

(71) Applicant: TOYOTA JIDOSHA KABUSHIKI KAISHA, Toyota-shi (JP)

(72) Inventors: Kazunori SHIBATA, Mishima-shi (JP); Hikaru HASEGAWA, Numazu-shi (JP); Hideo NAKAMURA, Susono-shi (JP)

(73) Assignee: TOYOTA JIDOSHA KABUSHIKI KAISHA, Toyota-shi (JP)

(21) Appl. No.: 17/662,740

(22) Filed: May 10, 2022

(30) Foreign Application Priority Data
May 14, 2021 (JP) 2021-082268

(51) Int. Cl. H01M 8/1004; H01M 8/0247

(52) U.S. Cl. CPC H01M 8/1004; H01M 8/0247

(57) ABSTRACT

A fuel cell comprising a membrane electrode gas diffusion layer assembly, a resin frame, a first separator and a second separator, wherein the resin frame comprises an opening in which the membrane electrode gas diffusion layer assembly can be disposed, and a skeleton surrounding the opening, and wherein the second separator comprises a convexity at four corners of a region which is a part abutting the resin frame and which faces an inner peripheral edge of the skeleton, and the second separator abuts the resin frame in a state that the convexities are engaged with the resin frame, or wherein the second separator comprises an adhesive at the four corners of the region which is the part abutting the resin frame and which faces the inner peripheral edge of the skeleton, and the second separator is attached to the resin frame via the adhesive.

### TECHNICAL FIELD

The disclosure relates to a fuel cell.

### BACKGROUND

A fuel cell (FC) is a power generation device which is composed of a single unit fuel cell (hereinafter, it may be referred to as “cell”) or a fuel cell stack composed of stacked unit fuel cells (hereinafter, it may be referred to as “stack”) and which generates electrical energy by electrochemical reaction between fuel gas (e.g., hydrogen) and oxidant gas (e.g., oxygen). In many cases, the fuel gas and oxidant gas actually supplied to the fuel cell, are mixtures with gases that do not contribute to oxidation and reduction. Especially, the oxidant gas is often air containing oxygen.

Hereinafter, fuel gas and oxidant gas may be collectively and simply referred to as “reaction gas” or “gas”. Also, a single unit fuel cell and a fuel cell stack composed of stacked unit cells may be referred to as “fuel cell”.

In general, the unit fuel cell includes a membrane-electrode assembly (MEA).

The membrane electrode assembly has a structure such that a catalyst layer and a gas diffusion layer (or GDL, hereinafter it may be simply referred to as “diffusion layer”) are sequentially formed on both surfaces of a solid polymer electrolyte membrane (hereinafter, it may be simply referred to as “electrolyte membrane” or “membrane”). Accordingly, the membrane electrode assembly may be referred to as “membrane electrode gas diffusion layer assembly” (MEGA).

As needed, the unit fuel cell includes two separators sandwiching both sides of the membrane electrode gas diffusion layer assembly. In general, the separators have a structure such that a groove is formed as a reaction gas flow path on a surface in contact with the gas diffusion layer. The separators have electronic conductivity and function as a collector of generated electricity.

In the fuel electrode (anode) of the fuel cell, hydrogen (H₂) as the fuel gas supplied from the gas flow path and the gas diffusion layer, is protonated by the catalytic action of the catalyst layer, and the protonated hydrogen goes to the oxidant electrode (cathode) through the electrolyte membrane. An electron is generated at the same time, and it passes through an external circuit, does work, and then goes to the cathode. Oxygen (O₂) as the oxidant gas supplied to the cathode reacts with protons and electrons in the catalyst layer of the cathode, thereby generating water. The generated water gives appropriate humidity to the electrolyte membrane, and excess water penetrates the gas diffusion layer and then is discharged to the outside of the system.

A technique for integrally forming a membrane electrode assembly and a seal member has been proposed to prevent a leakage of fuel gas and oxidant gas from a fuel cell.

For example, Patent Literature 1 discloses a technique to prevent separation of the electrolyte membrane and seal member of a seal gasket integrated MEA in a fuel cell stack.

Patent Literature 2 discloses a fuel cell in which an adhesive is used and a technique to reduce air bubbles in the adhesive.

Patent Literature 3 discloses a fuel battery that has both of excellent gas sealing performance for preventing external leakage and excellent electrical insulation performance.

Patent Literature 4 discloses a method of producing a frame-equipped electrolyte membrane/electrode assembly which can increase the rigidity of a portion of a frame member facing the buffer of a separator and can also reduce production cost, along with a frame-equipped electrolyte membrane/electrode assembly and a fuel cell.

Patent Literature 1: Japanese Patent Application Laid-Open (JP-A) No. 2008-034156

Patent Literature 2: JP-A No. 2018-073523

Patent Literature 3: JP-A No. 2016-085892

Patent Literature 4: JP-A No. 2020-119885

A fuel cell is generally a cuboid due to the constraints of space for mounting the fuel cell. A membrane electrode assembly is also quadrangular, accordingly. The resin frame employed in Patent Literature 1 is also formed into a shape following the periphery of a membrane electrode assembly, that is, a quadrangular shape having an opening. When temperature of the fuel cell decreases and the resin frame is exposed to low temperature, strain stress is concentratedly produced at the four corners of the opening, by deformation associated with thermal shrinkage. Accordingly, such a problem occurs that the resin frame is split.

### SUMMARY

The present disclosure was achieved in light of the above circumstances. An object of the present disclosure is to provide a fuel cell configured to suppress the generation of strain stress.

The fuel cell of the present disclosure is a fuel cell comprising a membrane electrode gas diffusion layer assembly, a resin frame, a first separator and a second separator,

wherein the membrane electrode gas diffusion layer assembly comprises a first gas diffusion layer, a first catalyst layer, an electrolyte membrane, a second catalyst layer and a second gas diffusion layer in this order,

wherein the membrane electrode gas diffusion layer assembly is in an approximately rectangular shape;

wherein the resin frame is disposed in the periphery of the membrane electrode gas diffusion layer assembly and is disposed between the first separator and the second separator;

wherein the resin frame comprises an opening in which the membrane electrode gas diffusion layer assembly can be disposed, and a skeleton surrounding the opening; and

wherein the second separator comprises a convexity at four corners of a region which is a part abutting the resin frame and which faces an inner peripheral edge of the skeleton, and the second separator abuts the resin frame in a state that the convexities are engaged with the resin frame, or

wherein the second separator comprises an adhesive at the four corners of the region which is the part abutting the resin frame and which faces the inner peripheral edge of the skeleton, and the second separator is attached to the resin frame via the adhesive.

In the fuel cell of the present disclosure,

the second separator may comprise a convexity at four corners of a region which is a part abutting the resin frame and which faces an inner peripheral edge of the skeleton;

the second separator may comprise an adhesive at the four corners of the region which is the part abutting the resin frame and which faces the inner peripheral edge of the skeleton; and

the second separator may abut the resin frame in a state that the convexities are engaged with the resin frame, and the second separator may be attached to the resin frame via the adhesive.

According to the fuel cell of the present disclosure, the generation of strain stress is suppressed.

### BRIEF DESCRIPTION OF THE DRAWINGS

In the accompanying drawings,

FIG. 1 is a schematic view of an example of the fuel cell of the present disclosure, and

FIG. 2 is a schematic cross-sectional view of an example of the fuel cell of the present disclosure, and it is also a view showing an example of one of the four corners of the inner peripheral edge of the skeleton of the resin frame, and the vicinity of the corner.

### DETAILED DESCRIPTION

The fuel cell of the present disclosure is a fuel cell comprising a membrane electrode gas diffusion layer assembly, a resin frame, a first separator and a second separator,

wherein the membrane electrode gas diffusion layer assembly comprises a first gas diffusion layer, a first catalyst layer, an electrolyte membrane, a second catalyst layer and a second gas diffusion layer in this order,

wherein the membrane electrode gas diffusion layer assembly is in an approximately rectangular shape;

wherein the resin frame is disposed in the periphery of the membrane electrode gas diffusion layer assembly and is disposed between the first separator and the second separator;

wherein the resin frame comprises an opening in which the membrane electrode gas diffusion layer assembly can be disposed, and a skeleton surrounding the opening; and

wherein the second separator comprises a convexity at four corners of a region which is a part abutting the resin frame and which faces an inner peripheral edge of the skeleton, and the second separator abuts the resin frame in a state that the convexities are engaged with the resin frame, or

wherein the second separator comprises an adhesive at the four corners of the region which is the part abutting the resin frame and which faces the inner peripheral edge of the skeleton, and the second separator is attached to the resin frame via the adhesive.

According to the present disclosure, using the second separator, which are members abutting the resin frame, the resin frame is fixed by (1) a wedge effect or (2) an adhesive effect to reduce the deformation of the resin frame itself associated with thermal shrinkage.

According to the present disclosure, by the effect (1) or (2), strain deformation can be reduced when strain stress is generated at the four corners of the inner peripheral edge of the skeleton of the resin frame. Also, by the combining the effects (1) and (2), strain deformation can be more reduced.

According to the present disclosure, by pushing a part of the second separator into the resin frame without penetration through the resin frame, the movement of the resin frame itself in planar direction can be suppressed with suppressing the occurrence of cross leakage between the electrodes.

In the present disclosure, the fuel gas and the oxidant gas are collectively referred to as “reaction gas”. The reaction gas supplied to the anode is the fuel gas, and the reaction gas supplied to the cathode is the oxidant gas. The fuel gas is a gas mainly containing hydrogen, and it may be hydrogen. The oxidant gas may be oxygen, air, dry air or the like.

The fuel cell generally includes a unit fuel cell.

The fuel cell may be a fuel cell composed of a single unit fuel cell, or it may be a fuel cell stack composed of stacked unit fuel cells.

The number of the stacked unit fuel cells is not particularly limited. For example, 2 to several hundred unit fuel cells may be stacked; 2 to 600 unit fuel cells may be stacked; or 2 to 200 unit fuel cells may be stacked.

The fuel cell stack may include an end plate at both stacking-direction ends of each unit fuel cell.

The or each unit fuel cell of the fuel cell includes the membrane electrode gas diffusion layer assembly, the resin frame, the first separator and the second separator.

The membrane electrode gas diffusion layer assembly (MEGA) includes the first gas diffusion layer, the first catalyst layer, the electrolyte membrane, the second catalyst layer and the second gas diffusion layer in this order.

More specifically, the membrane electrode gas diffusion layer assembly includes an anode-side gas diffusion layer, an anode catalyst layer, the electrolyte membrane, a cathode catalyst layer and a cathode-side gas diffusion layer in this order.

The membrane electrode gas diffusion layer assembly is in the approximately rectangular shape.

One of the first and second catalyst layers is the cathode catalyst layer, and the other is the anode catalyst layer.

The cathode (oxidant electrode) includes the cathode catalyst layer and the cathode-side gas diffusion layer.

The anode (fuel electrode) includes the anode catalyst layer and the anode-side gas diffusion layer.

The first catalyst layer and the second catalyst layer are collectively referred to as “catalyst layer”. The cathode catalyst layer and the anode catalyst layer are collectively referred to as “catalyst layer”.

One of the first gas diffusion layer and the second gas diffusion layer is the cathode-side gas diffusion layer, and the other is the anode-side gas diffusion layer.

The first gas diffusion layer is the cathode-side gas diffusion layer when the first catalyst layer is the cathode catalyst layer. The first gas diffusion layer is the anode-side gas diffusion layer when the first catalyst layer is the anode catalyst layer. From the viewpoint of cost reduction, the first gas diffusion layer may be the cathode-side gas diffusion layer.

The second gas diffusion layer is the cathode-side gas diffusion layer when the second catalyst layer is the cathode catalyst layer. The second gas diffusion layer is the anode-side gas diffusion layer when the second catalyst layer is the anode catalyst layer.

The first gas diffusion layer and the second gas diffusion layer are collectively referred to as “gas diffusion layer” or “diffusion layer”. The cathode-side gas diffusion layer and the anode-side gas diffusion layer are collectively referred to as “gas diffusion layer” or “diffusion layer”.

In a plan view of the membrane electrode gas diffusion layer assembly, the peripheral edge of the first gas diffusion layer may be disposed outside the peripheral edge of the first catalyst layer, the peripheral edge of the electrolyte membrane, and the peripheral edge of the second catalyst layer. That is, the area of the first gas diffusion layer may be larger than the area of the first catalyst layer, the area of the electrolyte membrane, and the area of the second catalyst layer. The area of the first gas diffusion layer may be the same as or larger than the area of the second gas diffusion layer.

The gas diffusion layer may be a gas-permeable electroconductive member or the like.

As the electroconductive member, examples include, but are not limited to, a porous carbon material such as carbon cloth and carbon paper, and a porous metal material such as metal mesh and foam metal.

The fuel cell may include a microporous layer (MPL) between the catalyst layer and the gas diffusion layer. The microporous layer may contain a mixture of a water repellent resin such as PTFE and an electroconductive material such as carbon black.

The electrolyte membrane may be a solid polymer electrolyte membrane. As the solid polymer electrolyte membrane, examples include, but are not limited to, a hydrocarbon electrolyte membrane and a fluorine electrolyte membrane such as a thin, moisture-containing perfluorosulfonic acid membrane. The electrolyte membrane may be a Nafion membrane (manufactured by DuPont Co., Ltd.), for example.

The resin frame is disposed in the periphery of the membrane electrode gas diffusion layer assembly and is disposed between the first separator and the second separator.

The resin frame includes the opening in which the membrane electrode gas diffusion layer assembly can be disposed, and the skeleton surrounding the opening.

The skeleton is a main part of the resin frame, and it connects to the membrane electrode gas diffusion layer assembly.

In the present disclosure, the skeleton may be a region other than the opening of the resin frame.

The opening is a region retaining the membrane electrode gas diffusion layer assembly, and it is also a through-hole penetrating a part of the skeleton to set the membrane electrode gas diffusion layer assembly therein. In the resin frame, the opening may be disposed in the position where the skeleton is disposed around (in the periphery) of the membrane electrode gas diffusion layer assembly, or it may be disposed in the center of the resin frame.

The area of the opening of the resin frame may be a size such that the membrane electrode gas diffusion layer assembly can be disposed.

In a plan view of the resin frame and the membrane electrode gas diffusion layer assembly, the inner peripheral edge of the skeleton of the resin frame may be disposed more outside than the peripheral edge of the second gas diffusion layer. That is, the area of the opening of the resin frame may be larger than the area of the second gas diffusion layer.

The area of the opening of the resin frame may be the same as, smaller than, or larger than the area of the first gas diffusion layer. When the area of the opening of the resin frame is smaller than the area of the first gas diffusion layer, the peripheral edge of the first gas diffusion layer of the membrane electrode gas diffusion layer assembly may protrude in planar direction from the opening.

The resin frame may include supply holes and discharge holes.

The supply and discharge holes allows a fluid such as the reaction gas and the refrigerant to flow in the stacking direction of the unit fuel cells. The supply holes of the resin frame may be aligned and disposed to communicate with the supply holes of the separator. The discharge holes of the resin frame may be aligned and disposed to communicate with the discharge holes of the separator.

The resin frame may include a frame-shaped core layer and two frame-shaped shell layers disposed on both surfaces of the core layer, that is, a first shell layer and a second shell layer.

Like the core layer, the first shell layer and the second shell layer may be disposed in a frame shape on both surfaces of the core layer.

The core layer may be a structural member which has gas sealing properties and insulating properties. The core layer may be formed of a material such that the structure is unchanged at the temperature of hot pressing in a fuel cell production process. As the material for the core layer, examples include, but are not limited to, resins such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyethersulfone (PES), polyphenylsulfone (PPSU), liquid crystal polymer (LCP) and epoxy resin. The material for the core layer may be a rubber material such as ethylene propylene diene rubber (EPDM), fluorine-based rubber and silicon-based rubber.

From the viewpoint of ensuring insulating properties, the thickness of the core layer may be 5 μm or more, or it may be 30 μm or more. From the viewpoint of reducing the cell thickness, the thickness of the core layer may be 100 μm or less, or it may be 90 μm or less.

To attach the core layer to the anode-side and cathode-side separators and to ensure sealing properties, the first shell layer and the second shell layer may have the following properties: the first and second shell layers have high adhesion to other substances; they are softened at the temperature of hot pressing; and they have lower viscosity and lower melting point than the core layer. More specifically, the first shell layer and the second shell layer may be thermoplastic resin such as polyester-based resin and modified olefin-based resin, or they may be thermosetting resin such as modified epoxy resin. The first shell layer and the second shell layer may be the same kind of resin as the adhesive layer.

The resin for forming the first shell layer and the resin for forming the second shell layer may be the same kind of resin, or they may be different kinds of resins. By disposing the shell layers on both surfaces of the core layer, it becomes easy to attach the resin frame and the two separators by hot pressing.

From the viewpoint of ensuring adhesion, the thickness of the first and second shell layers may be 5 μm or more, or it may be 30 μm or more. From the viewpoint of reducing the cell thickness, the thickness of the first and second shall layers may be 100 μm or less, or it may be 40 μm or less.

In the resin frame, the first shell layer may be disposed only at a part that is attached to the anode-side separator, and the second shell layer may be disposed only at a part attached to the cathode-side separator. The first shell layer disposed on one surface of the core layer may be attached to the cathode-side separator. The second shell layer disposed on the other surface of the core layer may be attached to the anode-side separator. The resin frame may be sandwiched by the pair of separators.

One of the first separator and the second separator is the cathode-side separator, and the other is the anode-side separator.

The first separator is the cathode-side separator when the first catalyst layer is the cathode catalyst layer. The first separator is the anode-side separator when the first catalyst layer is the anode catalyst layer.

The second separator is the cathode-side separator when the second catalyst layer is the cathode catalyst layer. The second separator is the anode-side separator when the second catalyst layer is the anode catalyst layer.

The first separator and the second separator are collectively referred to as “separator”. The anode-side separator and the cathode-side separator are collectively referred to as “separator”.

The membrane electrode gas diffusion layer assembly is sandwiched by the first separator and the second separator.

The separator may include supply and discharge holes for allowing the fluid such as the reaction gas and the refrigerant to flow in the stacking direction of the unit fuel cells. As the refrigerant, for example, a mixed solution of ethylene glycol and water may be used to prevent freezing at low temperature.

As the supply hole, examples include, but are not limited to, a fuel gas supply hole, an oxidant gas supply hole, and a refrigerant supply hole.

As the discharge hole, examples include, but are not limited to, a fuel gas discharge hole, an oxidant gas discharge hole, and a refrigerant discharge hole.

The separator may include one or more fuel gas supply holes, one or more oxidant gas supply holes, one or more refrigerant supply holes, one or more fuel gas discharge holes, one or more oxidant gas discharge holes, and one or more refrigerant discharge holes.

The separator may include a reaction gas flow path on a surface in contact with the gas diffusion layer. Also, the separator may include a refrigerant flow path for keeping the temperature of the fuel cell constant, on the surface opposite to the surface in contact with the gas diffusion layer.

When the separator is the anode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The anode-side separator may include a fuel gas flow path for allowing the fuel gas to flow from the fuel gas supply hole to the fuel gas discharge hole, on the surface in contact with the anode-side gas diffusion layer. The anode-side separator may include a refrigerant flow path for allowing the refrigerant to from the refrigerant supply hole to the refrigerant discharge hole, on the surface opposite to the surface in contact with the anode-side gas diffusion layer.

When the separator is the cathode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The cathode-side separator may include an oxidant gas flow path for allowing the oxidant gas to flow from the oxidant gas supply hole to the oxidant gas discharge hole, on the surface in contact with the cathode-side gas diffusion layer. The cathode-side separator may include a refrigerant flow path for allowing the refrigerant to flow from the refrigerant supply hole to the refrigerant discharge hole, on the surface opposite to the surface in contact with the cathode-side gas diffusion layer.

The separator may be a gas-impermeable electroconductive member or the like. As the electroconductive member, examples include, but are not limited to, gas-impermeable dense carbon obtained by carbon densification, and a metal plate (such as an iron plate, an aluminum plate and a stainless-steel plate) obtained by press-molding. The separator may function as a collector.

The fuel cell stack may include a manifold such as an inlet manifold communicating between the supply holes and an outlet manifold communicating between the discharge holes.

As the inlet manifold, examples include, but are not limited to, an anode inlet manifold, a cathode inlet manifold and a refrigerant inlet manifold.

As the outlet manifold, examples include, but are not limited to, an anode outlet manifold, a cathode outlet manifold and a refrigerant outlet manifold.

The second separator includes a convexity at the four corners of the region which is a part abutting the resin frame and which faces the inner peripheral edge of the skeleton of the resin frame. The second separator may abut the resin frame in the state that the convexities are engaged with the resin frame, or the second separator may include the adhesive at the four corners of the region which is the part abutting the resin frame and which faces the inner peripheral edge of the skeleton of the resin frame, and the second separator may be attached to the resin frame via the adhesive. In this case, more specifically, the second separator may abut the four corners of the inner peripheral edge of the skeleton of the resin frame in the state that the convexities are engaged with the resin frame, or the second separator may be attached to the four corners of the inner peripheral edge of the skeleton of the resin frame via the adhesive.

In the present disclosure, the inner peripheral edge of the skeleton of the resin frame means a part of the region of the skeleton and the skeleton-side region near the boundary of the skeleton and the opening.

The material of the convexities may be the same as or different from the material of the separator. The convexities may be formed of a resin. As the resin, examples include, but are not limited to, a rubber-based resin such as a synthetic rubber-based resin and a fluoro rubber-based resin.

Compared to the convexities, the adhesive makes it easy to produce the fuel cell and can reduce the cost of the fuel cell. Compared to the adhesive, the convexities can firmly fix the resin frame and can more suppress the generation of strain stress.

The second separator may include a convexity at the four corners of the region which is the part abutting the resin frame and which faces the inner peripheral edge of the skeleton of the resin frame; the second separator may include the adhesive at the four corners of the region which is the part abutting the resin frame and which faces the inner peripheral edge of the skeleton of the resin frame; and the second separator may abut the resin frame in the state that the convexities are engaged with the resin frame, and the second separator may be attached to the resin frame via the adhesive. In this case, more specifically, the second separator may abut the four corners of the inner peripheral edge of the skeleton of the resin frame in the state that the convexities are engaged with the resin frame, and the second separator may be attached to the four corners of the inner peripheral edge of the skeleton of the resin frame via the adhesive.

The position of the adhesive and that of the convexities may be the same or different. The convexities can be engaged with the resin frame by disposing the adhesive more on or around the convexities; moreover, the separator can be attached to the resin frame by the adhesive. Accordingly, the resin frame can be fixed more firmly, and the generation of strain stress can be suppressed.

As the adhesive, for example, a commonly-used, polymer-based adhesive may be employed. As the adhesive, examples include, but are not limited to, silicon resin, epoxy resin, synthetic rubber-based resin, fluoro rubber-based resin, phenolic resin, acrylic resin, polyester resin, and modified alkyd-based resin.

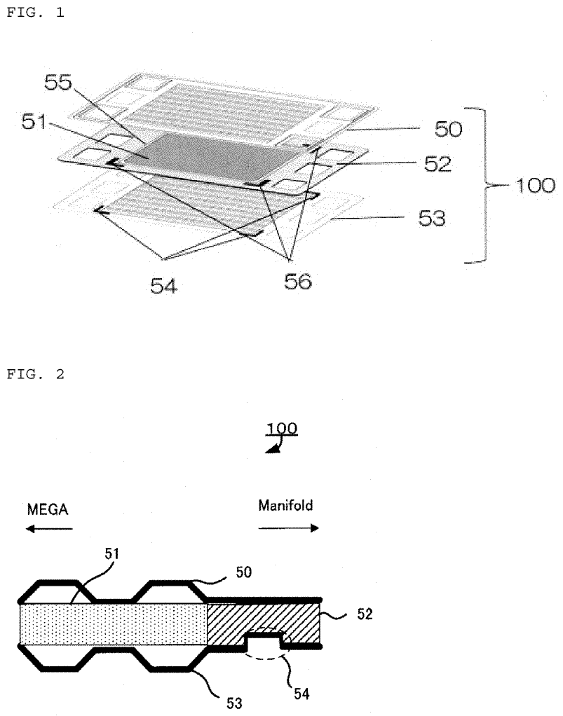

FIG. 1 is a schematic view of an example of the fuel cell of the present disclosure.

A fuel cell 100 shown in FIG. 1 includes a first separator 50, a membrane electrode gas diffusion layer assembly 51, a resin frame (skeleton) 52 and a second separator 53.

The resin frame 52 includes an opening 55. The membrane electrode gas diffusion layer assembly 51 is disposed in the opening 55. The peripheral edge of the first gas diffusion layer of the membrane electrode gas diffusion layer assembly 51 may protrude in planar direction from the opening 55.

The second separator 53 includes convexities (and/or adhesive) 54 formed at the corners of the region which is the part abutting the resin frame 52 and which faces the inner peripheral edge of the skeleton of the resin frame 52.

The convexities (and/or adhesive) 54 are engaged with the corners 56 of the inner peripheral edge of the skeleton of the resin frame 52. FIG. 1 only shows the convexities (and/or adhesive) 54 at three corners; however, the convexities (and/or adhesive) 54 are disposed at the four corners of the region which is the part abutting the resin frame 52 of the second separator 53 and which faces the inner peripheral edge of the skeleton of the resin frame 52.

FIG. 2 is a schematic cross-sectional view of an example of the fuel cell of the present disclosure, and it is also a view showing an example of one of the four corners of the inner peripheral edge of the skeleton of the resin frame, and the vicinity of the corner. Of the components shown in FIG. 2, the same components as those shown in FIG. 1 are not described here for simplicity.

In a fuel cell 100 shown in FIG. 2, a second separator 53 abuts the resin frame 52 in the state that the convexities 54 are engaged with the resin frame 52. An adhesive (not shown) may be disposed in place of the convexities 54, and the second separator 53 may be attached to the resin frame 52 via the adhesive. Also, an adhesive (not shown) may be disposed on the convexities 54; the second separator 53 may abut the resin frame 52 in the state that the convexities 54 are engaged with the four corners of the inner peripheral edge of the skeleton of the resin frame 52; and the second separator 53 may be attached to the four corners of the inner peripheral edge of the skeleton of the resin frame 52 via the adhesive.

### REFERENCE SIGNS LIST

50. First separator

51. Membrane electrode gas diffusion layer assembly

52. Resin frame

53. Second separator

54. Convexity (and/or adhesive)

55. Opening

56. Corner

100. Fuel cell

1. A fuel cell comprising a membrane electrode gas diffusion layer assembly, a resin frame, a first separator and a second separator,
wherein the membrane electrode gas diffusion layer assembly comprises a first gas diffusion layer, a first catalyst layer, an electrolyte membrane, a second catalyst layer and a second gas diffusion layer in this order,
wherein the membrane electrode gas diffusion layer assembly is in an approximately rectangular shape;
wherein the resin frame is disposed in the periphery of the membrane electrode gas diffusion layer assembly and is disposed between the first separator and the second separator;
wherein the resin frame comprises an opening in which the membrane electrode gas diffusion layer assembly can be disposed, and a skeleton surrounding the opening; and
wherein the second separator comprises a convexity at four corners of a region which is a part abutting the resin frame and which faces an inner peripheral edge of the skeleton, and the second separator abuts the resin frame in a state that the convexities are engaged with the resin frame, or
wherein the second separator comprises an adhesive at the four corners of the region which is the part abutting the resin frame and which faces the inner peripheral edge of the skeleton, and the second separator is attached to the resin frame via the adhesive.

2. The fuel cell according to claim 1,
wherein the second separator comprises a convexity at four corners of a region which is a part abutting the resin frame and which faces an inner peripheral edge of the skeleton;
wherein the second separator comprises an adhesive at the four corners of the region which is the part abutting the resin frame and which faces the inner peripheral edge of the skeleton; and
wherein the second separator abuts the resin frame in a state that the convexities are engaged with the resin frame, and the second separator is attached to the resin frame via the adhesive.
